(19) United States
(12) Patent Application Publication
(10) Pub. No.: US 2017/0267124 A1
(43) Pub. Date: Sep. 21, 2017

(54) VEHICLE SEAT APPARATUS

(71) Applicant: Fuji Jukogyo Kabushiki Kaisha, Tokyo (JP)

(72) Inventors: Koji NUMAZAWA, Tokyo (JP); Satoshi GOSHIMA, Tokyo (JP)

(21) Appl. No.: 15/387,400

(22) Filed: Dec. 21, 2016

(30) Foreign Application Priority Data
Mar. 18, 2016 (JP) 2016-055895

(51) Int. Cl. B60N 2/02; B60N 2/14; B60N 2/06

(52) U.S. Cl. CPC B60N 2/0244; B60N 2/0292; B60N 2/06; B60N 2/14

(57) ABSTRACT

A vehicle seat apparatus is configured to be mounted on a vehicle capable of traveling on a road. The vehicle seat apparatus includes a seat, an automatic driving unit, a seat drive, and a controller. The automatic driving unit performs automatic driving of the vehicle. The seat drive is configured to drive the seat to transition a position and attitude of the seat between a first mode and a second mode. The controller gives to the seat drive an instruction to transition the position and attitude of the seat from the first mode to the second mode when the controller recognizes that the vehicle travels in a particular section of the road, on a condition that the automatic driving unit performs the automatic driving.

### CROSS-REFERENCE TO RELATED APPLICATIONS

The present application claims priority from Japanese Patent Application No. 2016-055895 filed on Mar. 18, 2016, the entire contents of which are hereby incorporated by reference.

### BACKGROUND

The technology relates to a vehicle seat apparatus that is adapted to automatic driving.

Japanese Unexamined Patent Application Publication (JP-A) No. 2006-160178 discloses a vehicle seat apparatus that allows for layout of seats, as illustrated in FIGS. 7A and 7B. Referring to FIG. 7A, a vehicle 100 is a van, and includes a driver's seat 101 and a navigator's seat 102 that are disposed in the first row, and movable seats 103, 104, 105, and 106 that are disposed in the second and the third rows. The driver's seat 101, the navigator's seat 102, and the seats 103, 104, 105, and 106 are movable through longitudinal rails 107 and lateral rails 108 both disposed on the floor of a vehicle body, allowing those seats 101 to 106 to be disposed in various layouts.

As illustrated in an example of FIG. 7B, the driver's seat 101 is kept facing toward the front of the vehicle 100; however, the seat 104 in the second row is removable from the vehicle 100 to the outside to allow the navigator's seat 102 to be so disposed as to face the rear of the vehicle 100. Further, the navigator's seat 102 and the seats 103, 104, 105, and 106 are disposable so that they face the middle of the vehicle 100 to allow for traveling while occupants other than a driver face each other.

JP-A No. 2015-178332 discloses an automatic drive assist apparatus that informs a driver, by voice, of guidance information suggesting that automatic driving is to be discontinued, when a determination is made during the automatic driving that continuation of the automatic driving is not possible. The driver is thus able to know in advance that the automatic driving will be terminated before the automatic driving is terminated, making it possible for the driver to switch from the automatic driving to manual driving smoothly without haste.

### SUMMARY

Referring to FIG. 7B, the vehicle seat apparatus according to JP-A No. 2006-160178 allows the navigator's seat 102 and the seats 103, 104, 105, and 106 to be so disposed as to face the middle of the vehicle 100 during traveling of the vehicle 100, with the exception of the driver's seat 101. Thus, occupants are able to relax and make themselves comfortable to enjoy conversation, for example.

However, in an existing vehicle seat apparatus including that disclosed in JP-A No. 2006-160178, a driver steers the vehicle 100 by manual driving. Hence, in consideration of safety, it is not possible to arrange the driver's seat 101 freely during traveling of the vehicle 100.

It is desirable to provide a vehicle seat apparatus that performs arrangement of seats including a driver's seat to achieve comfort of occupants including a driver during automatic driving.

An aspect of the technology provides a vehicle seat apparatus configured to be mounted on a vehicle capable of traveling on a road, including a seat, an automatic driving unit that performs automatic driving of the vehicle; a seat drive configured to drive the seat to transition a position and attitude of the seat between a first mode and a second mode, and a controller that gives to the seat drive an instruction to transition the position and attitude of the seat from the first mode to the second mode when the controller recognizes that the vehicle travels in a particular section of the road, on a condition that the automatic driving unit performs the automatic driving.

The controller may give to the seat drive an instruction to automatically return the seat from the second mode to the first mode, on a condition that the controller recognizes that the vehicle is going to travel outside the particular section or the vehicle has traveled outside the particular section.

The vehicle seat apparatus may further include a traveling environment detector that detects a traveling environment of the vehicle. On a condition that the traveling environment detector recognizes a particular location in the particular section, the controller gives, before the vehicle reaches the particular location, to the seat drive an instruction to automatically return the seat from the second mode to the first mode.

The vehicle seat apparatus may further include a vehicle outside information detector that detects acquisition of particular vehicle outside information. The particular vehicle outside information may be particular information on outside of the vehicle. On a condition that the vehicle outside information detector detects the acquisition of the particular vehicle outside information in the particular section ahead of the vehicle in a traveling direction, the controller may give to the seat drive an instruction to automatically return the seat from the second mode to the first mode.

The vehicle seat apparatus may further include a notifying unit that notifies an occupant in the vehicle of information. After the notification unit notifies the occupant, as the information, that the controller may give to the seat drive the instruction to automatically return the seat from the second mode to the first mode, the controller gives to the seat drive the instruction to automatically return the seat from the second mode to the first mode.

The vehicle seat apparatus may further include a vehicle outside information detector that detects acquisition of particular vehicle outside information. The particular vehicle outside information may be particular information on outside of the vehicle. The vehicle outside information detector may detect the acquisition of the particular vehicle outside information in the particular section ahead of the vehicle in a traveling direction, On a condition that it is difficult for the vehicle to avoid the particular vehicle outside information, the controller may prohibit the seat drive from automatically returning the seat from the second mode to the first mode.

The vehicle seat apparatus may further include a notifying unit that notifies an occupant in the vehicle of information. The notifying unit may notify the occupant of the particular vehicle outside information which is difficult to avoid, as the information.

An aspect of the technology provides a vehicle seat apparatus configured to be mounted on a vehicle capable of traveling on a road, including a seat, a seat drive configured to drive the seat to transition a position and attitude of the seat between a first mode and a second mode, and circuitry configured to perform automatic driving of the vehicle, and give to the seat drive an instruction to transition the position and attitude of the seat from the first mode to the second mode when the vehicle is recognized to travel in a particular section of the road, on a condition that the automatic driving is performed.

### BRIEF DESCRIPTION OF THE DRAWINGS

FIG. 1 is a block diagram illustrating an outline of a vehicle seat apparatus according to one implementation of the technology.

FIGS. 2A and 2B are explanatory perspective views of a vehicle in which the vehicle seat apparatus according to one implementation of the technology is disposed.

FIG. 3 is a flowchart illustrating an example of a control operation performed in the vehicle seat apparatus according to one implementation of the technology.

FIG. 4 is a flowchart illustrating an example of a control operation performed in the vehicle seat apparatus according to a first modification example of one implementation of the technology.

FIG. 5 is a flowchart illustrating an example of a control operation performed in the vehicle seat apparatus according to a second modification example of one implementation of the technology.

FIG. 6 is a flowchart illustrating an example of a control operation performed in the vehicle seat apparatus according to a third modification example of one implementation of the technology.

FIGS. 7A and 7B are explanatory top views of an existing vehicle seat apparatus.

### DETAILED DESCRIPTION

In the following, a vehicle seat apparatus according to one implementation of the technology is described in detail with reference to the drawings. Note that the like elements are basically denoted with the same reference numerals for description of one implementation, and any repetitive description thereof is omitted.

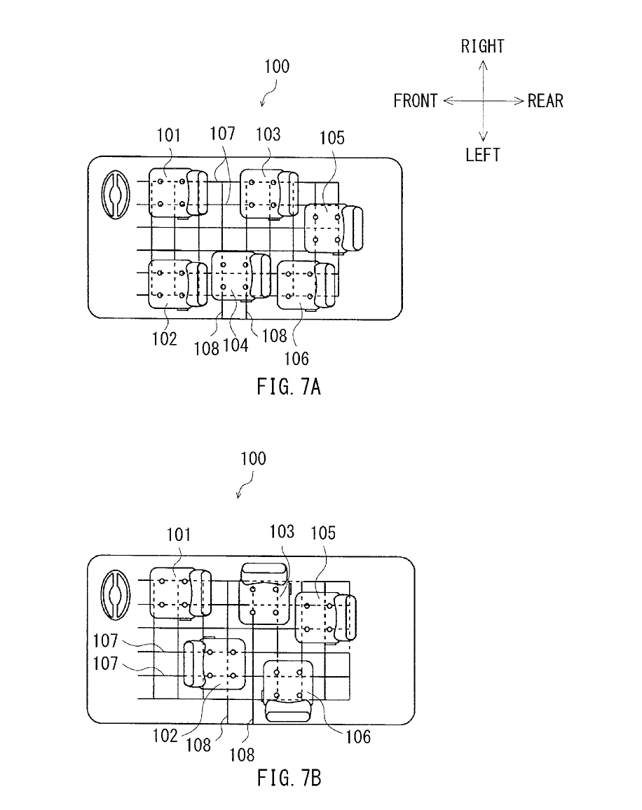

As described above, the vehicle seat apparatus according to JP-A No. 2006-160178 illustrated in FIGS. 7A and 7B lacks an automatic driving function and thus involves manual driving by a driver constantly. Hence, during traveling of the vehicle 100, no necessity arises in the vehicle seat apparatus according to JP-A No. 2006-160178 that the seats following the arrangement have to be returned to their original seat positions that are before the arrangement.

The automatic drive assist apparatus according to JP-A No. 2015-178332 informs a driver that automatic driving is to be discontinued, when a determination is made that continuation of the automatic driving is not possible, making it possible for the driver to switch smoothly from the automatic driving to manual driving without haste.

However, an existing automatic driving assist apparatus, including that disclosed in JP-A No. 2015-178332, also fails to achieve, following the arrangement of the seats during the automatic driving, returning of the seats to their states that are before the arrangement in a situation where, for example, the determination is made that the continuation of the automatic driving is not possible.

In other words, an existing vehicle seat apparatus lacks the following structures and functions according to one implementation of the technology. What is therefore desired is a vehicle seat apparatus that performs, under a safe road environment, arrangement of seats including a driver's seat to achieve comfort of occupants including a driver during automatic driving, and secures safety of the occupants by automatically returning the seats to their states that are before the arrangement under a certain condition.

One implementation of the technology provides a vehicle seat apparatus that achieves traveling that combines both comfort and safety of occupants, by determining deformation or movement of a seat in an automatic driving state on the basis of a road environment and by automatically returning the seat having been subjected to the deformation or the movement to its original state under a certain condition.

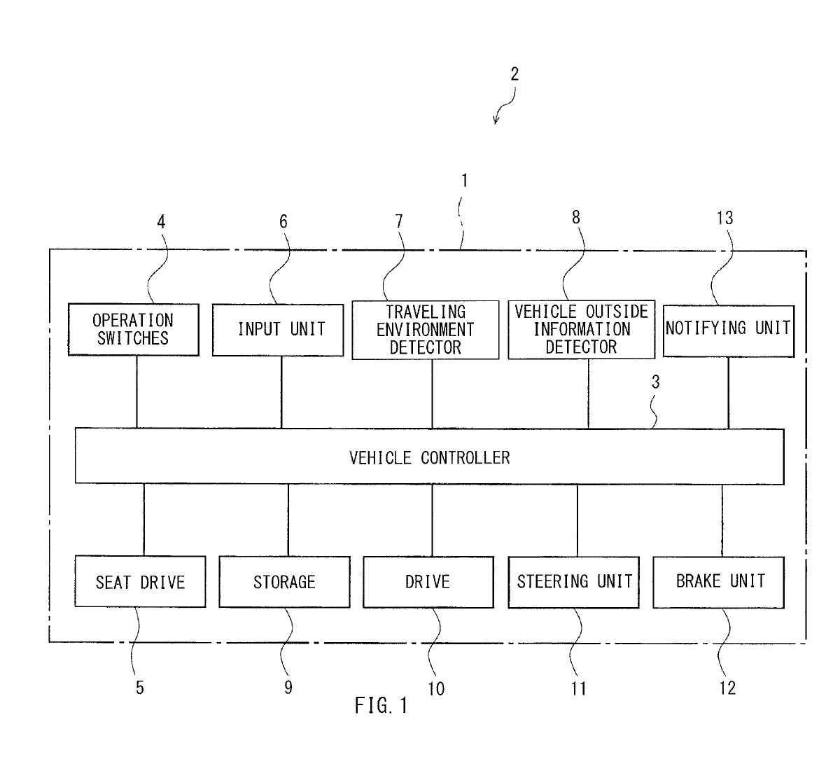

FIG. 1 is a block diagram illustrating an outline of a vehicle seat apparatus 1 according to one implementation of the technology. The vehicle seat apparatus 1 may be mounted on a vehicle 2, and moves a position or varies an attitude of any seat in accordance with an environment under which the vehicle 2 travels. In other words, the vehicle seat apparatus 1 deforms or moves any seat. The environment may be a road environment, a traveling environment, or any other environment under which the vehicle 2 travels.

Referring to FIG. 1, the vehicle seat apparatus 1 may mainly include a vehicle controller 3, operation switches 4, a seat drive 5, an input unit 6, a traveling environment detector 7, a vehicle outside information detector 8, a storage 9, a drive 10, a steering unit 11, a brake unit 12, and a notifying unit 13.

The vehicle controller 3 may have devices including a central processing unit (CPU), a read-only memory (ROM), and a random access memory (RAM). The vehicle controller 3 may be an electronic control unit (ECU) that performs operations including various calculations that are directed to a vehicle control. Alternatively, the vehicle controller 3 may be any other device having a control function. On the basis of information received from the traveling environment detector 7, the vehicle controller 3 may perform various calculations, etc., to identify whether a road along which the vehicle 2 currently travels corresponds to a particular section in which a transition to a relax mode is possible.

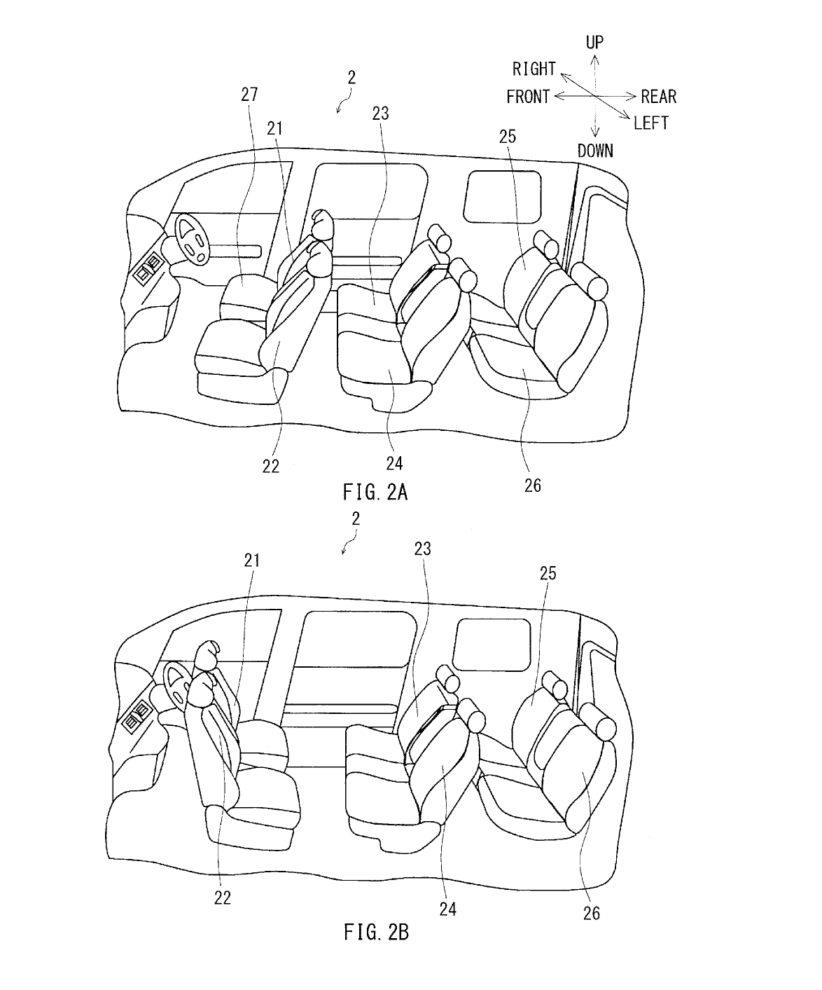

Referring to FIG. 2, the operation switches 4 may be provided on a side surface of a seat cushion 27 of a driver's seat 21, for example. The side surface of the seat cushion 27 may be located on the driver's door side. The operation switches 4 may be coupled to the vehicle controller 3, and one of the operation switches 4 may be an operation switch 4 directed to the relax mode. The operation switch 4 directed to the relax mode may be provided solely for the driver's seat 21. In an alternative example, however, the operation switch 4 directed to the relax mode may be provided for each of seats 22 to 26, or may be provided on a member such as a steering wheel and an instrument panel.

The seat drive 5 may be a drive mechanism that moves the position or varies the attitude of each of the seats 21 to 26 (see FIG. 2) provided in the vehicle 2, and has devices including a link mechanism, an electric motor, an actuator, and an electric hydraulic device. The seat drive 5 may be coupled to the vehicle controller 3, and move the position or vary the attitude of each of the seats 21 to 26 in accordance with an operation of the operation switches 4. Further, as described later in greater detail, the seat drive 5 may return, upon the relax mode, the positions and the attitudes of the respective seats 21 to 26 to their original states, when the vehicle controller 3 makes a determination that the positions and the attitudes of the respective seats 21 to 26 are to be automatically returned to their original states. The vehicle controller 3 may make the determination during the relax mode and in accordance with an environment such as the road environment under which the vehicle 2 travels. In one implementation of the present invention, the original state may serve as a “first mode” and the relaxing mode may serve as a “second mode”.

The input unit 6 may include a device operable by an occupant such as a driver, such as a touch panel and switches including push buttons. Non-limiting examples of the switches of the input unit 6 may include an engine switch that causes an engine to start and stop, and an automatic driving switch that starts and ends automatic driving. The input unit 6 may be coupled to the vehicle controller 3, and may start, upon satisfaction of a certain condition, the automatic driving of the vehicle 2 under the control of the vehicle controller 3 in accordance with an operation of the input unit 6.

The traveling environment detector 7 may include a navigation device that measures a position of the vehicle 2, an electronic toll collection system (ETC) device, and various detectors that detect a traveling environment of the vehicle 2. The traveling environment detector 7 may be coupled to the vehicle controller 3.

The navigation device may have road information and map information, and may display the map information and the position of the vehicle 2 in a superimposed fashion. The road information may include pieces of information on roads such as freeways and national roads. The map information may include pieces of information on service areas (SA) and parking areas (PA) both in the freeways. The position of the vehicle 2 as an own vehicle position may be obtained from a global positioning system (GPS) satellite. The vehicle controller 3 may control the navigation device to detect the road environment by means of the own vehicle position obtained from the GPS satellite. The road environment may relate to a road along which the vehicle 2 currently travels, and to positions of junctions (JC) and interchanges (IC) of the freeways. Information on the road along which the vehicle 2 currently travels may be obtained from the ETC device and the navigation device.

Non-limiting examples of the various sensors mounted on the vehicle 2 may include a vehicle speed detector, a fuel injection amount detector, a brake detector, a throttle opening level detector, a steering wheel angle sensor, and a lateral acceleration sensor. The vehicle controller 3 may calculate detection data obtained by means of each of the detectors to detect a current traveling situation of the vehicle 2. For example, the vehicle controller 3 may detect a traveling situation of the vehicle 2 from the detection data obtained from each of the various detectors described above upon entering a freeway from an interchange and merging into a main line of the freeway, in order to perform, for avoiding contact with any other vehicle traveling the main line, operations such as acceleration and deceleration of the vehicle 2 and changing of traveling lanes.

The vehicle outside information detector 8 may have devices including a stereo camera that recognizes an environment outside the vehicle 2, a sensor such as a millimeter wave radar device disposed in a front-rear direction of the vehicle 2, and a communicator that performs road-to-vehicle communication. The vehicle outside information detector 8 may be coupled to the vehicle controller 3.

The stereo camera may include charge-coupled device (CCD) cameras disposed on right and left as a set. The stereo camera may perform stereo photography of a region ahead of the vehicle 2 from different perspectives to obtain information such as information on the traveling environment ahead of the vehicle 2. The traveling environment may relate to a preceding vehicle and a traveling path. The stereo camera allows for acquisition of information that is relatively near the vehicle 2, within a range in which the stereo photography is possible. For example, the stereo camera may be able to acquire the information related to a situation in which a sudden accident has occurred ahead of the vehicle 2, or to a situation in which any other vehicle has carried out emergency stop ahead of the vehicle 2.

The communicator may include a device based on an intelligent transport system (ITS) in an example where the communicator performs the road-to-vehicle communication. The communicator may receive signals transmitted from road facilities including an optical beacon and a radio wave beacon to obtain various pieces of information such as traffic jam information, weather information, and information on traffic control performed in a particular section. The communicator allows for acquisition of information that is directed to a region in which the acquisition of information by the stereo camera is not possible. For example, the communicator may be able to acquire the information related to a situation in which an accident has occurred at a location on the freeway which is five kilometers ahead of the vehicle 2 and lane restriction has been carried out accordingly.

The storage 9 may include a memory device such as a random access memory (RAM) and a read-only memory (ROM), and may be coupled to the vehicle controller 3. The storage 9 may store, as seat information, information that indicates the position and the attitude of the seat in manual driving which are before making the transition to the relax mode. For example, the position and the attitude of the seat may include a position in the front-rear direction of the seat, an angle of a seat back, a position in an up-down direction of the seat cushion 27, an inclination angle of the seat cushion 27, a position in an up-down direction of a headrest, and an angle of the headrest. One implementation may include a so-called seat memory mechanism that automatically adjusts, on the basis of the seat information stored in the storage 9, the position and the attitude of the seat suitable for the driver when the driver has seated on the seat and has performed a predetermined input operation.

The drive 10 may have devices including an engine as a drive source that causes the vehicle 2 to run. The steering unit 11 may have devices including a steering that steers the vehicle 2. The brake unit 12 may have devices including a brake that performs deceleration and stopping of the vehicle 2.

The vehicle controller 3 may switch between the manual driving and the automatic driving, on the basis of instructions outputted from the input unit 6. The manual driving is normal driving in which the driver performs a driving operation. The automatic driving is driving in which the vehicle controller 3 performs the driving automatically. Upon the automatic driving, the vehicle controller 3 may execute various calculations on the basis of pieces of information supplied from the devices including the traveling environment detector 7 and the vehicle outside information detector 8. By executing the various calculations, the vehicle controller 3 may constantly monitor factors including the current traveling environment and the environment outside the vehicle 2. The vehicle controller 3 may further control the devices including the drive 10, the steering unit 11, and the brake unit 12 to perform the appropriate automatic driving in accordance with a current situation. The vehicle controller 3 may thus have the automatic driving function and may be able to perform the automatic driving operation of the vehicle 2.

The notifying unit 13 may be a device such as a speaker and a display. The speaker may output sound, voice, or a combination thereof which provides the occupants with an aural notification. The display may display an image or any other visual factor which provides the occupant with a visual notification. The sound and voice may be outputted by means of the speaker provided in the vehicle 2, and the image may be outputted by means of, for example, a screen of the navigation device provided in the vehicle 2. Note that setting of factors such as contents of notification and a time during which the notification is performed may be varied between a notification performed in a normal situation and a notification performed upon emergency. The notification may be performed on the occupants severely especially in an emergency to increase safety of the occupants.

FIGS. 2A and 2B are each a perspective view of a vehicle interior of the vehicle 2 according to one implementation as seen from the left front side.

FIG. 2A illustrates arrangement of the seats of the vehicle 2 following starting of the manual driving of the vehicle 2 by the driver and before making the transition to the relax mode. For example, the vehicle 2 may be a van, and may have three rows of seats in the front-rear direction of the vehicle 2. The vehicle 2 may include the driver's seat 21 disposed on right side of the first row, the navigator's seat 22 disposed on left side of the first row, the right seat 23 and the left seat 24 each disposed in the second row, and the right seat 25 and the left seat 26 each disposed in the third row. The attitude of the driver's seat 21 is set to a driving position at which the traveling of the vehicle 2 is performable safely, in consideration of the manual driving of the vehicle 2 which is performed by the driver sitting on the driver's seat 21.

FIG. 2B illustrates arrangement of the seats of the vehicle 2 after making the transition to the relax mode. For example, the transition to the relax mode may be made when the vehicle 2 travels a freeway in which the automatic driving is possible and may be made under a certain condition. In the relax mode, the driver's seat 21 and the navigator's seat 22 in the first row may be so moved as to be rotated at a 180-degree angle in a horizontal plane and thereby face the right seat 23 and the left seat 24 in the second row, enabling the traveling of the vehicle 2 while allowing the occupants including the driver to face each other and have conversation in a relaxed fashion.

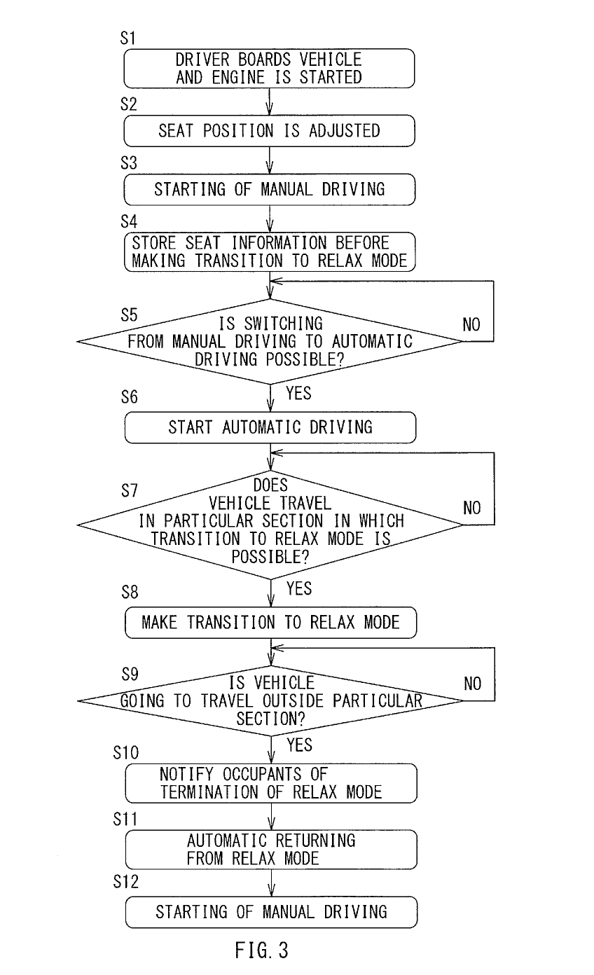

FIG. 3 is a flowchart illustrating an example of a control operation performed in the vehicle seat apparatus 1 according to one implementation of the technology.

Referring to FIG. 3, in step S1, the occupant such as the driver may board the vehicle 2, and the vehicle controller 3 may control the devices including the drive 10 to start the engine and any other device in response to pressing by the driver of the engine switch of the input unit 6. Thereafter, in step S2, the vehicle controller 3 may control the seat drive 5 to vary the attitude of any of the seats 21 to 26 to an attitude suitable for the corresponding occupant, when any of the occupants including the driver operates the operation switches 4 of corresponding one of the seats 21 to 26 (see FIG. 2A). Thereafter, in step S3, the driver may operate the steering unit 11 and the brake unit 12 to start the manual driving of the vehicle 2.

In step S4, the vehicle controller 3 may control the storage 9 to store, as the positions and the attitudes of the seats 21 to 26 which are before making the transition to the relax mode and in the form of the seat information, the position and the attitude of each of the seats 21 to 26 which are at the time before the starting of the manual driving. For example, the position and the attitude of each of the seats 21 to 26 may include the position in the front-rear direction of the corresponding seat, the angle of the corresponding seat back, the position in the up-down direction of the corresponding seat cushion 27, the inclination angle of the corresponding seat cushion 27, the position in the up-down direction of the corresponding headrest, and the angle of the corresponding headrest.

In step S5, the vehicle controller 3 may make a determination as to whether the starting of the automatic driving is possible. Specifically, when the driver operates the automatic driving switch of the input unit 6, the vehicle controller 3 may control the traveling environment detector 7 and the vehicle outside information detector 8, and execute various calculations on the basis of pieces of information obtained from the traveling environment detector 7 and the vehicle outside information detector 8. By executing the various calculations, the vehicle controller 3 may recognize factors including the current traveling environment and the road environment of the road along which the vehicle 2 travels to determine whether the starting of the automatic driving is possible.

When the vehicle controller 3 determines that the starting of the automatic driving is possible, i.e., when YES is satisfied in step S5, the flow may proceed to step S6. In step S6, the vehicle controller 3 may control the drive 10, the steering unit 11, and the brake unit 12 to start the automatic driving that is appropriate to a current situation. When the vehicle controller 3 determines that the starting of the automatic driving is not possible, i.e., when NO is satisfied in step S5, the vehicle controller 3 may continue placing the vehicle 2 in a manual driving state. In this case, the driver may be allowed to operate the automatic driving switch where appropriate.

In step S7, the vehicle controller 3 may make a determination as to whether the vehicle 2 travels a particular section in which the transition to the relax mode is possible. Specifically, when the vehicle 2 is in an automatic driving state and any of the occupants operates the switch of the operation switches 4 directed to the relax mode, the vehicle controller 3 may control the traveling environment detector 7 to obtain, from the navigation device of the traveling environment detector 7, pieces of information such as information on the current vehicle position and information on the road along which the vehicle 2 currently travels. By obtaining the pieces of information, the vehicle controller 3 may determine whether the vehicle 2 travels the particular section.

When the vehicle controller 3 determines that the road along which the vehicle 2 currently travels corresponds to the particular section in which the transition to the relax mode is possible, i.e., when YES is satisfied in step S7, the flow may proceed to step S8. In step S8, the vehicle controller 3 may permit making of the transition to the relax mode. For example, upon making the transition, the vehicle controller 3 may control the seat drive 5 to move and rotate the driver's seat 21 and the navigator's seat 22 in the first row at the 180-degree angle, and thereby to deform or move each of the seats 21 to 26 so that the driver's seat 21 and the navigator's seat 22 face the right seat 23 and the left seat 24 disposed in the second row, as illustrated in FIG. 2B.

When the vehicle controller 3 determines that the road along which the vehicle 2 currently travels does not correspond to the particular section in which the transition to the relax mode is possible, i.e., when NO is satisfied in step S7, the vehicle controller 3 may continue placing the vehicle 2 in the automatic driving state without making the transition to the relax mode. In this case, any of the occupants including the driver may be allowed to operate the switch of the operation switches 4 directed to the relax mode where appropriate.

A description is given of some non-limiting examples in which the vehicle controller 3 identifies that the road along which the vehicle 2 currently travels does not correspond to the particular section. For example, the vehicle controller 3 may identify a section directed to merging into a main line of a freeway, certain sections before and after the merging section, a junction section, and certain sections before and after the junction section as sections that are not the particular section, even when the road along which the vehicle 2 travels is the freeway and even when the vehicle 2 is in the automatic driving state. One reason is that, in the section directed to merging into the main line of the freeway and the certain sections before and after the merging section, operations such as acceleration and deceleration of the vehicle 2 and changing of traveling lanes are performed frequently to avoid contact of the merging vehicle 2 with any other vehicle traveling the main line, and that the preparation for an unforeseen situation is desirable in those sections until the vehicle 2 is in a stable traveling environment. Similarly, the junction section and the certain sections before and after the junction section involve the merging into a main line of a freeway again after the vehicle 2 has traveled away from a main line of a freeway and has traveled a curved road section, and that the preparation for an unforeseen situation is also desirable in those sections until the vehicle 2 is in the stable traveling environment as described above. In the freeway, the vehicle controller 3 may identify sections of the freeway other than, for example, the section directed to merging into the main line of the freeway, the certain sections before and after the merging section, the junction section, and the certain sections before and after the junction section as the particular sections.

The vehicle controller 3 may identify the particular section on the basis of the pieces of information obtained from the navigation device of the traveling environment detector 7 as described above. The identification of the particular section, however, is not limited to the foregoing example. In an alternative example, the vehicle controller 3 may calculate the detection data obtained from each of the detectors provided in the traveling environment detector 7 to detect the current traveling situation of the vehicle 2 and thereby identify whether the road along which the vehicle 2 currently travels corresponds to the particular section. For example, the vehicle controller 3 may determine that the traveling situation of the vehicle 2 is not stable and thus identify that the road along which the vehicle 2 currently travels does not correspond to the particular section, in circumstances where various pieces of data related to the traveling situation do not fall within their predetermined threshold ranges. Non-limiting examples of such circumstances may include large fluctuation in vehicle speed and large variation in steering wheel angle.

In step S9, while the vehicle 2 is in the automatic driving state and travels the particular section, the vehicle controller 3 may control the traveling environment detector 7 to determine whether the vehicle 2 is going to travel outside the particular section. When the vehicle controller 3 detects, on the basis of the navigation device of the traveling environment detector 7 controlled by the vehicle controller 3, that the vehicle 2 is going to travel outside the currently-traveling particular section, i.e., when YES is satisfied in step S9, the flow may proceed to step S10. In step S10, the vehicle controller 3 may control the notifying unit 13 to notify the occupants of termination of the relax mode. For example, the vehicle controller 3 may notify, by voice, the occupants of the termination of the relax mode by outputting voice announcement such as “The relax mode is about to be finished. Please be prepared for returning of seats”. When the vehicle controller 3 does not detect that the vehicle 2 is going to travel outside the currently-traveling particular section, i.e., when NO is satisfied in step S9, the vehicle 2 keeps on traveling the particular section and thus the vehicle controller 3 may continue the relax mode.

A description is given of one example in which the vehicle controller 3 detects that the vehicle 2 is going to travel outside the particular section. For example, an interchange as an entrance of a freeway and an interchange as an exit of the freeway may be set, when the driver performs setting of a destination and a traveling route by means of the navigation device of the traveling environment detector 7 before starting the traveling of the vehicle 2. Note that the freeway may serve as the particular section. Under such circumstances, when the vehicle 2 travels the freeway and reaches, for example, a location that is one kilometer to go before reaching the exit interchange, the vehicle controller 3 may detect that the vehicle 2 is close to the exit interchange from which the vehicle 2 leaves the freeway. Upon leaving the freeway, the manual driving by the driver may be preferable over the automatic driving in terms of safety, in that performing operations such as traveling away from the main line of the freeway and traveling a curved road near the exit interchange may be necessary. Hence, after detecting that the vehicle 2 is going to travel outside the particular section, the vehicle controller 3 may first notify, by voice and/or any other method, the occupants of the termination of the relax mode by means of the speaker and/or any other method provided in the vehicle 2, to allow the occupants to be informed in advance of the forthcoming variation or the forthcoming movement of the seats 21 to 26. Accordingly, the occupants are able to be prepared mentally and set for the variation and/or the movement of each of the seats 21 to 26, and are thus able to deal with the variation and/or the movement of each of the seats 21 to 26 smoothly.

After step S10, the flow may proceed to step S11 in which the seats 21 to 26 are automatically returned to the original states, i.e., their positions and attitudes before making the transition to the relax mode. Specifically, the vehicle controller 3 may control the seat drive 5 and the storage 9 to read the data on the positions and the attitudes of the seats 21 to 26 which are at the time before making the transition to the relax mode, and to automatically return the seats 21 to 26 to their positions and attitudes which are at the time before making the transition to the relax mode as illustrated in FIG. 2A. Thereafter, in step S12, switching from the automatic driving to the manual driving may be performed when the driver operates the automatic driving switch of the input unit 6 again in the automatic driving state. The driver may operate the devices including the steering unit 11 and the brake unit 12 to start the manual driving of the vehicle 2 again.

Note that the relax mode is terminated when the vehicle controller 3 has detected the location that is one kilometer before the exit interchange of the freeway, i.e., when the vehicle controller 3 has detected that the vehicle 2 is going to travel outside the particular section, in the foregoing example of the control operation performed in the vehicle seat apparatus 1. The control operation, however, is not limited to the foregoing example. In an alternative example where the ETC device of the traveling environment detector 7 is utilized, the relax mode may be terminated after the vehicle controller 3 has detected, by wireless communication performed when the vehicle 2 passes through an ETC lane at the exit interchange of the freeway, that the vehicle 2 has traveled outside the particular section.

Further, in the foregoing example of the control operation performed in the vehicle seat apparatus 1, the position and the attitude of each of the seats 21 to 26 which are at the time after the starting of the manual driving are stored in the storage 9 to allow the seats 21 to 26 to be returned to those positions and attitudes upon returning from the relax mode. The control operation, however, is not limited to the foregoing example. In an alternative example, the position and the attitude of each of the seats 21 to 26 upon the returning from the relax mode may be based on the position and the attitude of each of the seats 21 to 26 which are stored in the storage 9 at the time of the starting of the engine, or at the time of the starting of the automatic driving. In a further alternative example, the position and the attitude of each of the seats 21 to 26 upon the returning from the relax mode may be based on the position and the attitude of each of the seats 21 to 26 which are set in advance in the storage 9.

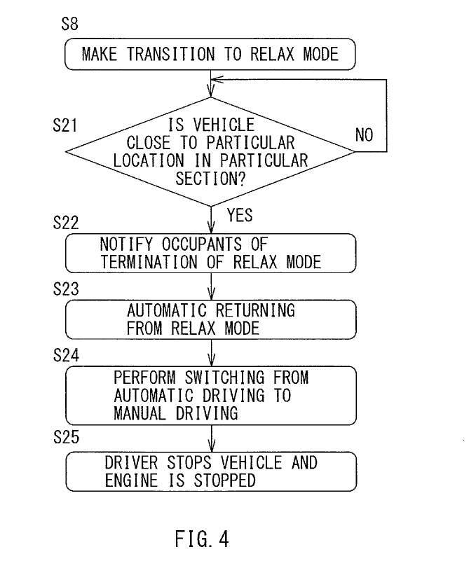

FIG. 4 is a flowchart illustrating an example of a control operation performed in the vehicle seat apparatus 1 according to a first modification example of one implementation. Referring to FIG. 4, the control operation according to the first modification example may be the same as the control operation described above with reference to FIG. 3 from step S1 to step S8. The control operation illustrated in FIG. 4 may be directed to an example where the vehicle 2 makes a brief visit to a particular location in the particular section after making the transition to the relax mode. Non-limiting examples of the particular location may include the service areas and the parking areas in a freeway. In the following, a description is mainly given on step S21 and steps subsequent thereto, and the description on steps S1 to S8 is omitted to avoid any repetitive description. For the description on steps S1 to S8, reference is made to the description given above on the basis of FIG. 3.

Referring to FIG. 4, in step S21, the vehicle controller 3 may detect whether the vehicle 2 is close to the particular location in the particular section. Specifically, while the vehicle 2 is in the automatic driving state and travels the particular section and after making the transition to the relax mode in step S8, the vehicle controller 3 may control the traveling environment detector 7 to detect whether the vehicle 2 is close to the particular location in the particular section.

When the vehicle controller 3 detects, on the basis of the navigation device of the traveling environment detector 7 controlled by the vehicle controller 3, that the vehicle 2 is close to the particular location in the particular section, i.e., when YES is satisfied in step S21, the flow may proceed to step S22. In step S22, the vehicle controller 3 may control the notifying unit 13 to notify the occupants of the termination of the relax mode. For example, the vehicle controller 3 may notify, by voice, the occupants of the termination of the relax mode by outputting voice announcement such as “The relax mode is about to be finished. Please be prepared for returning of seats”. When the vehicle controller 3 does not detect that the vehicle 2 is close to the particular location in the particular section, i.e., when NO is satisfied in step S21, the vehicle 2 keeps on traveling the particular section and thus the vehicle controller 3 may continue the relax mode.

A description is given of one example in which the vehicle controller 3 detects that the vehicle 2 is close to the particular location in the particular section. For example, a location such as the service area and the parking area (i.e., rest area) of a freeway may be set as a location to which a brief visit is to be made, when the driver performs setting of a destination and a traveling route by means of the navigation device of the traveling environment detector 7 before starting the traveling of the vehicle 2. Note that the freeway may serve as the particular section. Under such circumstances, when the vehicle 2 travels the freeway and reaches, for example, a location that is one kilometer to go before reaching the preset service area or the preset parking area, the vehicle controller 3 may detect that the vehicle 2 is close to the service area or the parking area to which the brief visit is to be made. In the service area or the parking area of the freeway, performing the manual driving while visually confirming the surrounding environment outside the vehicle 2 by the driver may be preferable in terms of increased safety, in that the service area and the parking area involve easier congestion of vehicles. For example, the congestion of vehicles occurs easily due to entry and exit of the vehicles into and from parking lot of the service area or the parking area, or due to the vehicle that makes a stop at the parking lot. Performing the manual driving may also be preferable in the service area or the parking area in that, for example, a person may suddenly run in front of the vehicle 2 from a space between the stopped vehicles. Hence, after detecting that the vehicle 2 is close to the particular location in the particular section, the vehicle controller 3 may first notify, by voice and/or any other method, the occupants of the termination of the relax mode by means of the speaker and/or any other method provided in the vehicle 2, to allow the occupants to be informed in advance of the forthcoming variation or the forthcoming movement of the seats 21 to 26. Accordingly, the occupants are able to be prepared mentally and set for the variation and/or the movement of each of the seats 21 to 26, and are thus able to deal with the variation and/or the movement of each of the seats 21 to 26 smoothly.

After step S22, the flow may proceed to step S23 in which the seats 21 to 26 are automatically returned to their positions and attitudes which are at the time before making the transition to the relax mode. Specifically, the vehicle controller 3 may control the seat drive 5 and the storage 9 to read the data on the positions and the attitudes of the seats 21 to 26 which are at the time before making the transition to the relax mode, and to automatically return the seats 21 to 26 to their positions and attitudes which are at the time before making the transition to the relax mode as illustrated in FIG. 2A. Thereafter, in step S24, the switching from the automatic driving to the manual driving may be performed when the driver operates the automatic driving switch of the input unit 6 again in the automatic driving state. The driver may operate the devices including the steering unit 11 and the brake unit 12 to start the manual driving of the vehicle 2 again. Thereafter, in step S25, the driver may stop the vehicle 2 at the parking lot by the manual driving, and the engine may be stopped when the driver presses the engine switch of the input unit 6.

The control operation performed in the vehicle seat apparatus 1, upon traveling the freeway as an example of the particular section again after having finished errands at the service area or the parking area, may be the same as steps S1 to S12 of the control operation described with reference to FIG. 3.

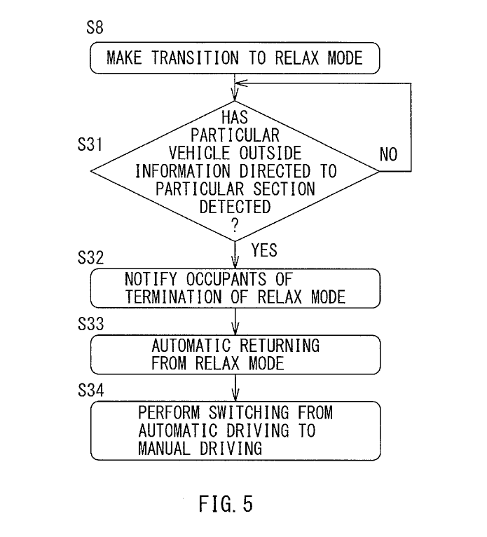

FIG. 5 is a flowchart illustrating an example of a control operation performed in the vehicle seat apparatus 1 according to a second modification example of one implementation. Referring to FIG. 5, the control operation according to the second modification example may be the same as the control operation described above with reference to FIG. 3 from step S1 to step S8. The control operation illustrated in FIG. 5 may be directed to an example where particular vehicle outside information is detected in the particular section after making the transition to the relax mode. For example, the particular vehicle outside information may be information indicating that traffic control is performed due to an occurrence of a traffic accident at, for example, a location three kilometers ahead of the vehicle 2 that travels the freeway. In the following, a description is mainly given on step S31 and steps subsequent thereto, and the description on steps S1 to S8 is omitted to avoid any repetitive description. For the description on steps S1 to S8, reference is made to the description given above on the basis of FIG. 3.

Referring to FIG. 5, in step S31, the vehicle controller 3 may detect whether the vehicle 2 has acquired the particular vehicle outside information directed to the particular section. Specifically, while the vehicle 2 is in the automatic driving state and travels the particular section and after making the transition to the relax mode in step S8, the vehicle controller 3 may control the vehicle outside information detector 8 to detect whether the vehicle 2 has acquired the particular vehicle outside information directed to the particular section.

When the vehicle controller 3 detects, by means of, for example, the road-to-vehicle communication performed by the vehicle outside information detector 8 controlled by the vehicle controller 3, that the vehicle 2 has acquired the particular vehicle outside information directed to the particular section, i.e., when YES is satisfied in step S31, the flow may proceed to step S32. In step S32, the vehicle controller 3 may control the notifying unit 13 to notify the occupants of the termination of the relax mode. For example, the vehicle controller 3 may notify, by voice, the occupants of the termination of the relax mode by outputting voice announcement such as “The relax mode is about to be finished. Please be prepared for returning of seats”. When the vehicle controller 3 does not detect that the vehicle 2 has acquired the particular vehicle outside information directed to the particular section, i.e., when NO is satisfied in step S31, the vehicle 2 keeps on traveling the particular section and thus the vehicle controller 3 may continue the relax mode.

A description is given of one example in which the vehicle controller 3 detects that the vehicle 2 has acquired the particular vehicle outside information directed to the particular section. For example, upon the traveling of the vehicle 2 on the freeway, the vehicle controller 3 may detect, by means of the road-to-vehicle communication, that the vehicle 2 has obtained the information indicating that the traffic control is performed due to the occurrence of the traffic accident at the location three kilometers ahead of the vehicle 2. Note that the freeway may serve as the particular section. In such a case, the manual driving by the driver may be preferable over the automatic driving in terms of safety, in that a traffic jam may occur due to the traffic control and a necessity may arise where the vehicle 2 needs to travel the road shoulder to bypass an accident vehicle accordingly. Hence, after detecting that the vehicle 2 has acquired the particular vehicle outside information directed to the particular section, the vehicle controller 3 may first notify, by voice and/or any other method, the occupants of the termination of the relax mode by means of the speaker and/or any other method provided in the vehicle 2, to allow the occupants to be informed in advance of the forthcoming variation or the forthcoming movement of the seats 21 to 26. Accordingly, the occupants are able to be prepared mentally and set for the variation and/or the movement of each of the seats 21 to 26, and are thus able to deal with the variation and/or the movement of each of the seats 21 to 26 smoothly.

After step S32, the flow may proceed to step S33 in which the seats 21 to 26 are automatically returned to their positions and attitudes which are at the time before making the transition to the relax mode. Specifically, the vehicle controller 3 may control the seat drive 5 and the storage 9 to read the data on the positions and the attitudes of the seats 21 to 26 which are at the time before making the transition to the relax mode, and to automatically return the seats 21 to 26 to their positions and attitudes which are at the time before making the transition to the relax mode as illustrated in FIG. 2A. Thereafter, in step S34, the switching from the automatic driving to the manual driving may be performed when the driver operates the automatic driving switch of the input unit 6 again in the automatic driving state. The driver may operate the devices including the steering unit 11 and the brake unit 12 to start the manual driving of the vehicle 2 again.

The control operation performed by the vehicle seat apparatus 1, upon traveling the particular section again after having traveled outside the traffic controlled section due to the traffic accident, may be the same as steps S1 to S12 of the control operation described with reference to FIG. 3.

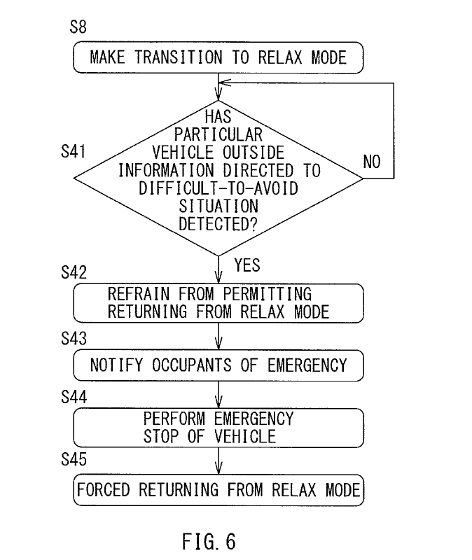

FIG. 6 is a flowchart illustrating an example of a control operation performed in the vehicle seat apparatus 1 according to a third modification example of one implementation. Referring to FIG. 6, the control operation according to the third modification example may be the same as the control operation described above with reference to FIG. 3 from step S1 to step S8. The control operation illustrated in FIG. 6 may be directed to an example where particular vehicle outside information related to a situation that is difficult to avoid is detected in the particular section after making the transition to the relax mode. For example, the particular vehicle outside information related to the difficult-to-avoid situation may be information detected by the stereo camera provided in the vehicle outside information detector 8, and indicating that a traffic accident has occurred immediately in front of the vehicle 2. In the following, a description is mainly given on step S41 and steps subsequent thereto, and the description on steps S1 to S8 is omitted to avoid any repetitive description. For the description on steps S1 to S8, reference is made to the description given above on the basis of FIG. 3.

Referring to FIG. 6, in step S41, the vehicle controller 3 may detect whether the vehicle 2 has acquired the particular vehicle outside information that is related to the difficult-to-avoid situation and directed to the particular section.

Specifically, while the vehicle 2 is in the automatic driving state and travels the particular section and after making the transition to the relax mode in step S8, the vehicle controller 3 may control the vehicle outside information detector 8 to detect whether the vehicle 2 has acquired the particular vehicle outside information that is related to the difficult-to-avoid situation and directed to the particular section.

When the vehicle controller 3 detects, by means of, for example, the stereo camera provided in the vehicle outside information detector 8 controlled by the vehicle controller 3, that the vehicle 2 has acquired the particular vehicle outside information that is related to the difficult-to-avoid situation and directed to the particular section, i.e., when YES is satisfied in step S41, the flow may proceed to step S42. In step S42, the vehicle controller 3 may control the seat drive 5 to disable the operation of each of the seats 21 to 26 performed by the operation switches 4 and thereby to refrain from permitting the returning from the relax mode. Thereafter, in step S43, the vehicle controller 3 may control the notifying unit 13 to notify the occupants of an emergency by giving the occupants an emergency alarm or a warning. Alternatively, the vehicle controller 3 may notify, by voice, the occupants of the emergency by outputting an emergency message such as “Emergency stop activated”. When the vehicle controller 3 does not detect that the vehicle 2 has acquired the particular vehicle outside information that is related to the difficult-to-avoid situation and directed to the particular section, i.e., when NO is satisfied in step S41, the vehicle 2 keeps on traveling the particular section and thus the vehicle controller 3 may continue the relax mode.

A description is given of one example in which the vehicle controller 3 detects that the vehicle 2 has acquired the particular vehicle outside information that is related to the difficult-to-avoid situation and directed to the particular section. For example, upon the traveling of the vehicle 2 on the freeway, the vehicle controller 3 may detect, by means of the stereo camera, that the vehicle 2 has obtained the information indicating that the traffic accident has occurred immediately ahead of the vehicle 2. Note that the freeway may serve as the particular section. In such a case, avoiding contact with an accident vehicle may possibly involves difficulty in some cases even when the vehicle 2 executes an emergency stop, and the vehicle 2 may possibly hit against the accident vehicle. Further, in such a case, there is hardly any time for performing an operation based on the manual driving to avoid the accident vehicle, such as performing a steering wheel operation and a braking operation. Under such circumstances, the occupants may fail to be protected properly by devices such as airbag devices and may possibly be exposed to further risk when the vehicle 2 hits against the accident vehicle during the returning from the relax mode. In consideration of the emergency upon the relax mode, higher safety may be secured for a case where each of the occupants prepares for an accident, such as covering the head with his/her arms, while maintaining the relax mode than for a case where the returning from the relax mode is performed.

After step S43, the flow may proceed to step S44 in which the emergency stop is performed. Specifically, the vehicle controller 3 may control the drive 10, the steering unit 11, and the brake unit 12 to perform the emergency stop in which the vehicle 2 is stopped at a main line of the freeway that may serve as the particular section, or in which the vehicle 2 is stopped at the road shoulder of the freeway when the accident vehicle is avoidable. Thereafter, in step S45, the returning from the relax mode may be performed forcibly by, for example, operating the operation switches 4 when the vehicle 2 has no particular issue. The control operation performed by the vehicle seat apparatus 1 after the returning from the relax mode may be the same as steps S1 to S12 of the control operation described with reference to FIG. 3.

According to one implementation described above, the driver's seat 21 and the navigator's seat 22 in the first row are so moved as to be rotated at the 180-degree angle and thereby face the right seat 23 and the left seat 24 in the second row in the relax mode of the vehicle 2. The technology, however, is not limited thereto. In an alternative implementation, the occupant such as the driver may operate the operation switches 4 to vary the position and the attitude of any seat at the time of the relax mode, so that the driver's seat 21, the navigator's seat 22, or both is varied up to a fully-flat state, for example. In another alternative implementation, the occupant such as the driver may operate the operation switches 4 to, for example, move the steering wheel to the above so that the space for the driver to relax is provided. In a yet another implementation, the storage 9 may store in advance, in the form of data, several combinations of the positions and the attitudes of the seats that are variable or movable at the time of the relax mode. In this case, the occupant such as the driver may operate the operation switches 4 to select any of the combinations so that the seats are moved to their preset positions or varied to achieve their preset attitudes.

Further, according to one implementation described above, the driver's seat 21 is so moved, together with the navigator's seat 22, as to be rotated at the 180-degree angle and thereby face the right seat 23 and the left seat 24 in the second row in the relax mode. The technology, however, is not limited thereto. In an alternative implementation, the driver's seat 21 may keep facing the front of the vehicle 2 without being rotated even in the relax mode, for example. This allows at least the driver to maintain its posture that enables visual confirmation of a region at the front of the vehicle 2, making it possible to deal with an emergency situation of the vehicle 2 immediately upon occurrence of the emergency situation and thereby to achieve safer traveling of the vehicle 2.

Further, one implementation described above is based on a combination of the control method of the vehicle seat apparatus described with reference to FIG. 3 with any of the control methods of the vehicle seat apparatus described with reference to FIGS. 4 to 6. The technology, however, is not limited thereto. An alternative implementation of the technology may be based on a combination of all of the control methods of the vehicle seat apparatus described with reference to FIGS. 3 to 6. Hence, a combination of the control methods of the vehicle seat apparatus may be varied on an as-needed basis. Any other factor of one implementation described above may be variously modified in so far as they fall within the scope of the appended claims or the equivalents thereof.

In one implementation described above, the vehicle controller 3 may include a semiconductor integrated circuit that may have devices such as, but not limited to, the central processing unit (CPU), the ROM, and the RAM. In an alternative implementation, the vehicle controller 3 may include an integrated circuit such as, but not limited to, a field programmable gate array (FPGA) and an application specific integrated circuit (ASIC). The vehicle controller 3 or any other controller may include one or more central processing units, one or more FPGAs, and/or one or more ASICs.

The implementation also provides a program that causes a computer to function as the vehicle controller 3, and a recording medium that stores the program. The recording medium is computer readable. Non-limiting examples of the recording medium may include a flexible disk, a magneto-optical disk, ROM, CD, DVD (Registered Trademark), and BD (Registered Trademark). As used herein, the term “program” may refer to a data processor written in any language and any description method.

The vehicle seat apparatus according to one implementation allows for the transition to the relax mode that moves the position or varies the attitude of any seat provided in the vehicle, when the vehicle is in the automatic driving state and the vehicle travels the particular section. With this control, it is possible to achieve the vehicle seat apparatus that takes both the comfort of the occupants in the vehicle and the safety into consideration.

Upon the relax mode, the vehicle seat apparatus according to one implementation may automatically return the position and the attitude of the seat to the state that is before the relax mode is carried out when the vehicle is going to travel outside the particular section or has traveled outside the particular section. With this control, the driver is allowed to perform the manual driving in any section outside the particular section, making it possible to deal with an unforeseen situation easily and to improve the safety of the occupants in any section outside the particular section.

Upon the traveling of the vehicle in the particular section while carrying out the relax mode, the vehicle seat apparatus according to one implementation may automatically return the position and the attitude of the seat to the state that is before the relax mode is carried out when detecting that the vehicle is close to the particular location to which a brief visit is to be made such as the service area and the parking area of the freeway. With this control, the driver is allowed to perform the manual driving when the vehicle enters the particular location and stops at the particular location, making it possible to deal with an unforeseen situation easily and to improve the safety of the occupants at the particular location.

Upon the traveling of the vehicle in the particular section while carrying out the relax mode, the vehicle seat apparatus according to one implementation may automatically return the position and the attitude of the seat to the state that is before the relax mode is carried out when detecting that the particular vehicle outside information is acquired. For example, the particular vehicle outside information may be the information indicating that the traffic accident has occurred at a location on the freeway which is three kilometers ahead of the vehicle and the traffic control has been carried out accordingly. With this control, the driver is allowed to perform the manual driving in the traffic controlled section that involves, for example, the occurrence of the traffic jam resulting from the accident, making it possible to deal with an unforeseen situation easily and to improve the safety of the occupants in the traffic controlled section.

Upon the traveling of the vehicle in the particular section while carrying out the relax mode, the vehicle seat apparatus according to one implementation may first notify, by voice or any other method, the occupants that the automatic returning from the relax mode is to be performed when the position and the attitude of the seat are to be automatically returned to the state that is before the relax mode is carried out due to, for example, any of the reasons described above. With this control, the occupants are able to be prepared mentally and set for the movement of the seat, etc., and are thus able to deal with the movement of the seat, etc., smoothly.

Upon the traveling of the vehicle in the particular section while carrying out the relax mode, the vehicle seat apparatus according to one implementation may refrain from automatically returning the position and the attitude of the seat to the state that is before the relax mode is carried out when detecting that the particular vehicle outside information related to the difficult-to-avoid situation is acquired. For example, the particular vehicle outside information related to the difficult-to-avoid situation may be the information indicating that the traffic accident has suddenly occurred immediately in front of the vehicle. With this control, it is possible to prevent the occupants from being exposed to further risk upon, for example, the occurrence of the contact of the vehicle with any other vehicle during the returning from the relax mode, and to place maximum priority on the safety of the occupants.

Upon the traveling of the vehicle in the particular section while carrying out the relax mode, the vehicle seat apparatus according to one implementation may first notify, by voice or any other method, the occupants of possible risk when detecting that the particular vehicle outside information related to the difficult-to-avoid situation is acquired. For example, the particular vehicle outside information related to the difficult-to-avoid situation may be the information indicating that the traffic accident has suddenly occurred immediately in front of the vehicle. With this control, the occupants are each able to perform action that saves its life immediately, such as covering the head with his/her arms, making it possible to further increase the safety of the occupants.

Although some preferred implementations of the technology have been described in the foregoing by way of example with reference to the accompanying drawings, the technology is by no means limited to the implementations described above. It should be appreciated that modifications and alterations may be made by persons skilled in the art without departing from the scope as defined by the appended claims. The technology is intended to include such modifications and alterations in so far as they fall within the scope of the appended claims or the equivalents thereof.

1. A vehicle seat apparatus configured to be mounted on a vehicle capable of traveling on a road, the vehicle seat apparatus comprising:
a seat;
an automatic driving unit that performs automatic driving of the vehicle;
a seat drive configured to drive the seat to transition a position and attitude of the seat between a first mode and a second mode; and
a controller that gives to the seat drive an instruction to transition the position and attitude of the seat from the first mode to the second mode when the controller recognizes that the vehicle travels in a particular section of the road, on a condition that the automatic driving unit performs the automatic driving.

2. The vehicle seat apparatus according to claim 1, wherein the controller gives to the seat drive an instruction to automatically return the seat from the second mode to the first mode, on a condition that the controller recognizes that the vehicle is going to travel outside the particular section or the vehicle has traveled outside the particular section.

3. The vehicle seat apparatus according to claim 2, further comprising a traveling environment detector that detects a traveling environment of the vehicle,
wherein, on a condition that the traveling environment detector recognizes a particular location in the particular section, the controller gives, before the vehicle reaches the particular location, to the seat drive an instruction to automatically return the seat from the second mode to the first mode.

4. The vehicle seat apparatus according to claim 2, further comprising a vehicle outside information detector that detects acquisition of particular vehicle outside information, the particular vehicle outside information being particular information on outside of the vehicle,
wherein, on a condition that the vehicle outside information detector detects the acquisition of the particular vehicle outside information in the particular section ahead of the vehicle in a traveling direction, the controller gives to the seat drive an instruction to automatically return the seat from the second mode to the first mode.

5. The vehicle seat apparatus according to claim 2, further comprising a notifying unit that notifies an occupant in the vehicle of information,
wherein, after the notification unit notifies the occupant, as the information, that the controller gives to the seat drive the instruction to automatically return the seat from the second mode to the first mode, the controller gives to the seat drive the instruction to automatically return the seat from the second mode to the first mode.

6. The vehicle seat apparatus according to claim 3, further comprising a notifying unit that notifies an occupant in the vehicle of information,
wherein, after the notification unit notifies the occupant, as the information, that the controller gives to the seat drive the instruction to automatically return the seat from the second mode to the first mode, the controller gives to the seat drive the instruction to automatically return the seat from the second mode to the first mode.

7. The vehicle seat apparatus according to claim 4, further comprising a notifying unit that notifies an occupant in the vehicle of information,
wherein, after the notification unit notifies the occupant, as the information, that the controller gives to the seat drive the instruction to automatically return the seat from the second mode to the first mode, the controller gives to the seat drive the instruction to automatically return the seat from the second mode to the first mode.

8. The vehicle seat apparatus according to claim 2, further comprising a vehicle outside information detector that detects acquisition of particular vehicle outside information, the particular vehicle outside information being particular information on outside of the vehicle,
wherein the vehicle outside information detector detects the acquisition of the particular vehicle outside information in the particular section ahead of the vehicle in a traveling direction,
wherein on a condition that it is difficult for the vehicle to avoid the particular vehicle outside information, the controller prohibits the seat drive from automatically returning the seat from the second mode to the first mode.

9. The vehicle seat apparatus according to claim 8, further comprising a notifying unit that notifies an occupant in the vehicle of information,
wherein, the notifying unit notifies the occupant of the particular vehicle outside information which is difficult to avoid, as the information.

10. A vehicle seat apparatus configured to be mounted on a vehicle capable of traveling on a road, the vehicle seat apparatus comprising:
a seat;
a seat drive configured to drive the seat to transition a position and attitude of the seat between a first mode and a second mode; and
circuitry configured to
perform automatic driving of the vehicle, and
give to the seat drive an instruction to transition the position and attitude of the seat from the first mode to the second mode when the vehicle is recognized to travel in a particular section of the road, on a condition that the automatic driving is performed.
